(19) United States
(12) Patent Application Publication
(10) Pub. No.: US 2007/0292118 A1
(43) Pub. Date: Dec. 20, 2007

(54) UNDERWATER IMAGE CAPTURE

(75) Inventor: Eva Matilda TRÃFF, Lund (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/424,158

(22) Filed: Jun. 14, 2006

(51) Int. Cl. G03B 17/08

(52) U.S. Cl. 396/25

(57) ABSTRACT

A housing may include a first portion that includes a window configured to allow a lens to capture images viewed through the window, and a first mating surface. The housing may include a second portion that includes a second mating surface adapted to mate with the first mating surface to form a watertight seal, at least one button to provide a signal to a terminal supported in the second portion, and a receiving surface on an inner surface of the second portion adapted to receive an insert, where the insert is adapted to be removeably coupled to the receiving surface on a first side and to receive the terminal via a second side.

### BACKGROUND OF THE INVENTION

1. Technical Field of the Invention

Implementations described herein relate generally to cameras, and more particularly to performing operations using cameras.

2. Description of Related Art

Devices, such as mobile communication devices, may perform functions other than communication functions to make these devices more useful to consumers. For example, mobile communication devices may be configured to store and play music and/or video files and/or to record still images or video.

A consumer may find mobile communication devices with image capturing capabilities to be very useful as the consumer does not have to carry a separate camera to record images. Users may find that they take pictures with their mobile communications devices at a number of locations and in a number of different environments due to the portability of the mobile communications devices.

While camera equipped mobile communication devices may be satisfactory for taking pictures in some environments, they may not be able to take pictures in all of the environments that the user may desire. For example, camera equipped mobile communication devices may not be sealed with respect to moisture. Therefore, the user may not be able to take pictures in wet conditions. As a result, camera equipped mobile communication devices may not meet all of a user's photographic needs.

### BRIEF SUMMARY OF THE INVENTION

According to one aspect, a housing is provided. The housing may comprise a first portion, comprising a window configured to allow a lens to capture images viewed through the window, and a first mating surface. The housing may comprise a second portion, comprising a second mating surface adapted to mate with the first mating surface to form a watertight seal, at least one button to provide a signal to a terminal supported in the second portion, and a receiving surface on an inner surface of the second portion adapted to receive an insert, where the insert is adapted to be removeably coupled to the receiving surface on a first side and to receive the terminal via a second side.

Additionally, the second portion comprises an image window to provide image information related to a user when the user faces an outer surface of the second portion.

Additionally, the signal is produced in response to a user action.

Additionally, the first portion and the second portion are used with the terminal to take a picture underwater when the first portion and the second portion are mated together.

Additionally, the housing may further comprise a cable to connect the at least one button to the terminal, where the cable is adapted to carry the signal.

Additionally, the housing may further comprise a latch to maintain the first portion and the second portion in a mated relationship.

Additionally, the at least one button comprises a first button configured to turn on a camera included in the terminal and a second button configured to take a picture using the camera.

Additionally, the watertight housing is adapted to accept any of a plurality of inserts, where the plurality of inserts are adapted to receive a plurality of terminals having different sizes or shapes associated therewith.

In accordance with still another aspect, an insert is provided. The insert may comprise an upper surface adapted to receive a terminal, a supporting member adapted to maintain the terminal in a determined relationship with respect to the upper surface; and a lower surface adapted to releasably couple with an inner surface of a watertight housing, where the watertight housing is adapted to allow the terminal to take a picture while the watertight housing is submerged.

Additionally, the upper and lower surface form a receiving volume having a length varying from approximately 8 centimeters (cm) to 18 cm and a width varying from approximately 4 cm to 10 cm.

In accordance with yet another aspect, a housing is provided. The housing may comprise a window to allow subject information to reach a lens of a terminal supported in the housing, an insert supported via an inner surface of the housing, where the insert is adapted to receive the terminal and to maintain the terminal in a determined position with respect to the window, at least one input device located on an outer surface of the housing, a cable releasably coupled to the at least one input device via a first end and to the terminal via a second end, where the cable is adapted to pass a signal from the at least one input device to the terminal when the at least one input device is activated.

Additionally, the insert is adapted to be releasably supported via the inner surface of the housing.

Additionally, the cable is one of a plurality of cables that are adapted to connect the at least one input device to a plurality of different terminals.

Additionally, the inner surface of the housing is further configured to support a plurality of inserts associated with a plurality of different terminals.

Additionally, the cable or the at least one input device allow the terminal to be remotely controlled.

In accordance with still another aspect, a method is provided. The method may include receiving an insert adapted to support a terminal in a determined relationship with respect to an inner surface of an underwater housing, receiving the terminal via the insert and receiving a user input via a button while the underwater housing is substantially submerged. The method may comprise sending a signal related to the user input to the terminal via a cable, where the signal causes the terminal to capture an image via a lens proximate to a window in the underwater housing; and providing a representation of the captured image to the user through the underwater housing.

Additionally, the method may further comprise storing the captured image in a memory in response to a second user input received via a second button.

Additionally, the method may further comprise determining if water is present inside the underwater housing.

In accordance with yet another aspect, a device is provided. The device may comprise an enclosure configured to receive a mobile terminal, the enclosure forming a watertight seal; and at least one input device located on an outer surface of the enclosure, the at least one input device being configured to transmit electrical signals to a camera function of the mobile terminal when activated by a user.

Additionally, the device may further comprise an insert adapted to receive the mobile terminal, where the insert maintains the terminal in a determined relationship with respect to a window of the enclosure.

### BRIEF DESCRIPTION OF THE DRAWINGS

The accompanying drawings, which are incorporated in and constitute a part of this specification, illustrate one or more embodiments of the invention and, together with the description, explain the invention. In the drawings,

FIGS. 1A and 1B are diagrams of an exemplary implementation of a mobile terminal;

FIG. 2 illustrates an exemplary functional diagram of an implementation;

FIG. 3 illustrates an exemplary underwater housing;

FIG. 4A illustrates a rear portion of the exemplary underwater housing of FIG. 3;

FIG. 4B illustrates a front portion of the exemplary underwater housing of FIG. 3;

FIGS. 5A-5D illustrate exemplary inserts adapted for use with the underwater housing of FIG. 3; and

FIG. 6 illustrates an exemplary method consistent with the principles of the invention.

### DETAILED DESCRIPTION OF THE INVENTION

The following detailed description of the invention refers to the accompanying drawings. The same reference numbers in different drawings may identify the same or similar elements. Also, the following detailed description does not limit the invention.

Implementations of the invention can be used to perform operations related to capturing images. For example, a mobile terminal may be equipped with a digital camera. In an exemplary implementation, a user may use implementations to take a digital picture (image) using the mobile terminal while underwater.

Implementations may include an underwater housing that is adapted to receive a device that includes a camera (e.g., a digital camera and/or a mobile terminal equipped with a camera). The underwater housing may be sealed with the mobile terminal inside the housing to provide a dry environment for the mobile terminal.

The underwater housing may have controls to allow a user to operate picture taking functions in the mobile terminal while the mobile terminal is in the underwater housing. The underwater housing may have a front window proximate to a lens of the mobile terminal camera to allow the lens to capture images through the underwater housing. The underwater housing may have a rear window that faces the user so the user can see image information via a display on the mobile terminal. The underwater housing may be configured to accept a number of mobile terminal styles and sizes. For example, an implementation may accept a number of mobile terminal models sharing a common interface, such as a system connector. The implementation may use a harness to couple the mobile terminal to control buttons on the underwater housing so that functions of the mobile terminal can be accessed while the terminal is in the underwater housing.

Exemplary implementations of the invention will be described in the context of a mobile communications terminal. It should be understood that a mobile communications terminal is an example of one type of device that can employ image capturing techniques consistent with principles of the invention and should not be construed as limiting the types of devices, or applications, that can use image capturing techniques described herein. For example, image capturing techniques described herein, may be used in non-wireless devices, such as film-based cameras and/or digital cameras and/or other types of devices that can include camera-like functions to capture still or moving images.

### Exemplary Mobile Terminal

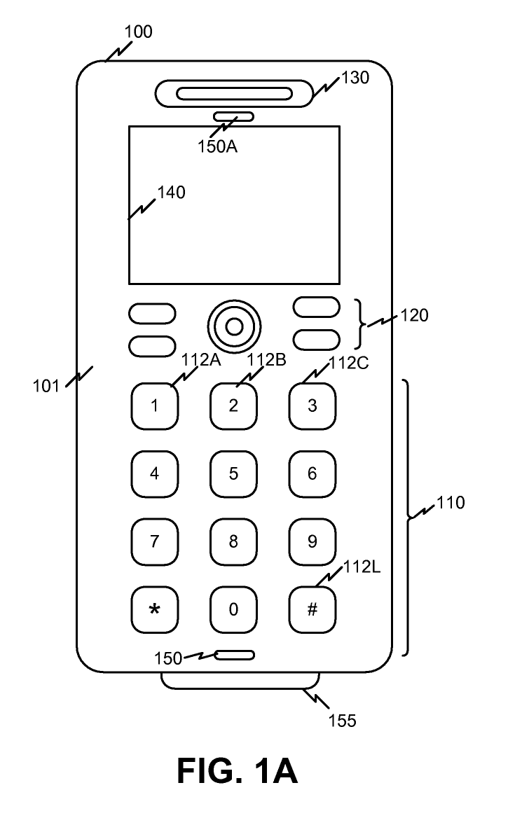

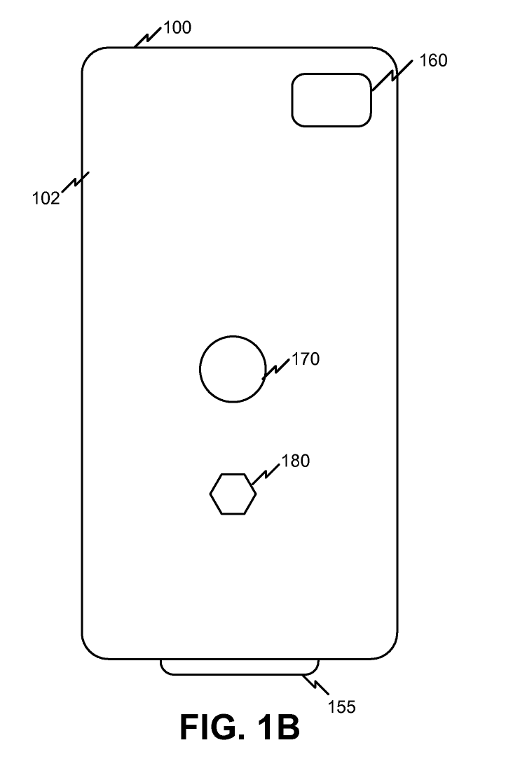

FIG. 1A is a diagram of an exemplary implementation of a mobile terminal 100 consistent with the principles of the invention. Mobile terminal 100 (hereinafter terminal 100) may be a mobile communication device. As used herein, a “mobile communication device” and/or “mobile terminal” may include a radiotelephone; a personal communications system (PCS) terminal that may combine a cellular radiotelephone with data processing, a facsimile, and data communications capabilities; a PDA that can include a radiotelephone, pager, Internet/intranet access, web browser, organizer, calendar, and/or global positioning system (GPS) receiver; and a laptop and/or palmtop receiver or other appliance that includes a radiotelephone transceiver.

Terminal 100 may include housing 101, keypad 110, control keys 120, speaker 130, display 140, microphones 150 and 150A, and system connector 155. Housing 101 may include a structure configured to hold devices and components used in terminal 100. For example, housing 101 may be formed from plastic, metal, or another material and may be configured to support keys 112A-L (collectively keys 112), control keys 120, speaker 130, display 140, microphone 150 or 150A, and/or system connector 155. In one implementation, housing 101 may form a front surface, or face of terminal 100.

Keypad 110 may include devices, such as keys 112A-L, that can be used to enter information into terminal 100. Keys 112 may be used in a keypad (as shown in FIG. 1A), in a keyboard, or in some other arrangement of keys. Implementations of keys 112 may have key information associated therewith, such as numbers, letters, symbols, etc. A user may interact with keys 112 to input key information into terminal 100. For example, a user may operate keys 112 to enter digits, commands, and/or text, into terminal 100.

Control keys 120 may include buttons that permit a user to interact with terminal 100 to cause terminal 100 to perform an action, such as to take a digital photograph using a digital camera embedded in terminal 100, display a text message via display 140, raise or lower a volume setting for speaker 130, etc. Speaker 130 may include a device that provides audible information to a user of terminal 100. Speaker 130 may be located in an upper portion of terminal 100 and may function as an ear piece or with an ear piece when a user is engaged in a communication session using terminal 100.

Display 140 may include a device that provides visual information to a user. For example, display 140 may provide information regarding incoming or outgoing calls, text messages, games, images, video, phone books, the current date/time, volume settings, etc., to a user of terminal 100. Display 140 may include touch-sensitive elements to allow display 140 to receive inputs from a user of terminal 100. Implementations of display 140 may display still images or video images that are received via a lens. Implementations of display 140 may further display information about devices sending information to terminal 100, such as base stations and/or other types of transmitters.

Microphones 150 and/or 150A may, respectively, include a device that converts speech or other acoustic signals into electrical signals for use by terminal 100. Microphone 150 may be located proximate to a lower side of terminal 100 and may convert spoken words or phrases into electrical signals for use by terminal 100. Microphone 150A may be located proximate to speaker 130 and may receive acoustic signals proximate to a user's ear while the user is engaged in a communications session using terminal 100.

FIG. 1B illustrates a back surface 102 of terminal 100. Back surface 102 may include a flash 160, a lens 170, and a range finder 180. Back surface 102 may be made of plastic, metal, and/or another material and may be configured to support flash 160, lens 170, and range finder 180.

Flash 160 may include a device to illuminate a subject that is being photographed with lens 170. Flash 160 may include an incandescent or other light source, light emitting diodes (LEDs), xenon-based light sources, and/or other types of illumination devices. Lens 170 may include a device to receive optical information related to an image. For example, lens 170 may receive optical reflections from a subject and may capture a digital representation of the subject using the reflections. Lens 170 may include optical elements, mechanical elements, and/or electrical elements that operate as part of a digital camera implemented in terminal 100.

Range finder 180 may include a device to determine a range from lens 170 to a subject (e.g., a subject being photographed using terminal 100). Range finder 180 may be connected to an auto-focus element in lens 170 to bring a subject into focus with respect to image capturing devices operating with lens 170. Range finder 180 may operate using ultrasonic signals, infrared signals, etc., consistent with principles of the invention.

### Exemplary Functional Diagram

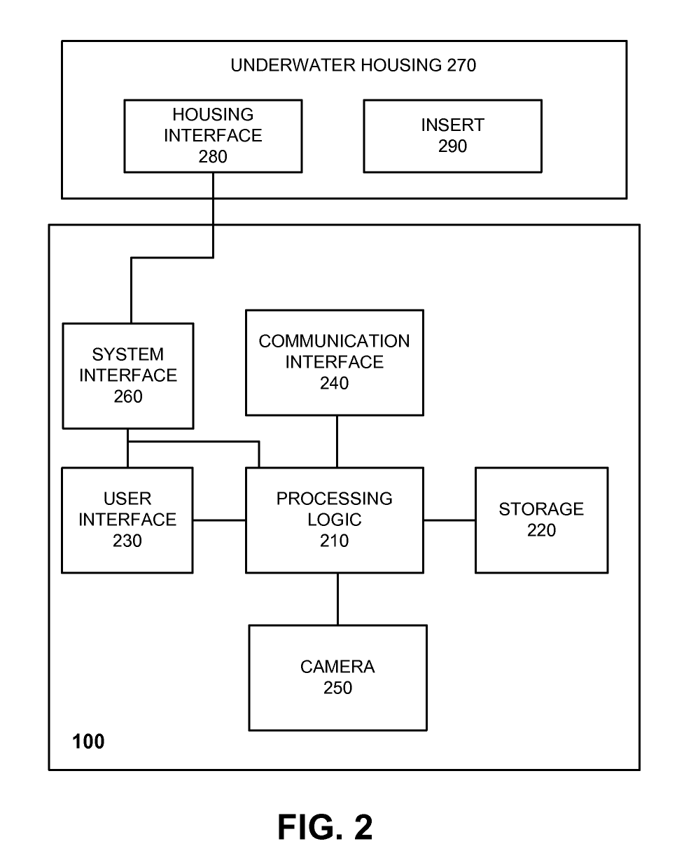

FIG. 2 illustrates an exemplary functional diagram that includes terminal 100 and underwater housing 270. In one implementation, underwater housing 270 may be adapted to enclose terminal 100 in a watertight environment. Alternative implementations may include more components, fewer components, and/or the components of FIG. 2 in an alternative arrangement.

As shown in FIG. 2, terminal 100 may include processing logic 210, storage 220, a user interface 230, a communication interface 240, a camera 250, and a system interface 260. Processing logic 210 may include a processor, microprocessor, an application specific integrated circuit (ASIC), field programmable gate array (FPGA), or the like. Processing logic 210 may include data structures or software programs to control operation of terminal 100 and its components, such as camera 250. Storage 220 may include a random access memory (RAM), a read only memory (ROM), a magnetic or optical disk and its corresponding drive and/or another type of memory to store data and instructions that may be used by processing logic 210.

User interface 230 may include mechanisms for inputting information to terminal 100 and/or for outputting information from terminal 100. Examples of input and output mechanisms might include a speaker (e.g., speaker 130) to receive electrical signals and output audio signals, a microphone (e.g., microphone 150 or 150A) to receive audio signals and output electrical signals, buttons (e.g., control keys 120 and/or keys 112) to permit data and control commands to be input into terminal 100, a display (e.g., display 140) to output visual information, and/or a vibrator to cause terminal 100 to vibrate.

Communication interface 240 may include, for example, an antenna, a transmitter that may convert baseband signals from processing logic 210 to radio frequency (RF) signals and/or a receiver that may convert RF signals from the antenna to baseband signals. Alternatively, communication interface 240 may include a transceiver that performs the functions of both a transmitter and a receiver.

Camera 250 may include hardware and software based logic to record still or moving images using terminal 100. In one implementation, camera 250 may include solid-state image capturing components, such as charge coupled devices (CCDs), complementary metal oxide semiconductor (CMOS) devices, etc. In other implementations, camera 250 may include non-solid state devices, such as devices used to record images onto film. Camera 250 may receive subject information reflected off a subject being photographed via lens 170. Camera 250 may provide a representation of the subject information to a user via display 140 and/or another device.

System interface 260 may include hardware or software based logic to allow remote operation of terminal 100. For example, system interface 260 may allow remote operation of features of terminal 100, such as camera features, dialing features, display features, etc. Remote operation of terminal 100 may allow terminal 100 to perform functions without requiring that keys 112 and/or control keys 120 be depressed.

In an implementation, system interface 260 may receive information from an external device via system connector 155. System interface 260 may be adapted to send/receive commands (e.g., to dial a phone number, take a picture, store an image, focus a lens, and/or to power on/off terminal 100), send and/or receive data (e.g., image data, address book data, message data, etc.), and/or to send/receive instructions (e.g., code, such as software, to upgrade and/or add/remove features to terminal 100). For example, system interface 260 may receive a command from an external device (i.e., a device located outside underwater housing 270). The command may instruct terminal 100 to take a picture. System interface 260 may send the command to processing logic 210 and/or camera 250 to cause terminal 100 to take a picture.

Underwater housing 270 may include devices or structures to support terminal 100 in a first environment (e.g., a substantially dry environment) via an interior volume of underwater housing 270 while an exterior surface of underwater housing 270 is exposed to a second environment (e.g., a moisture containing environment, such as an underwater environment). Underwater housing 270 may be fabricated from plastic, glass, metal, a composite, etc. and may be substantially rigid with respect to pressure exerted on the exterior surface of underwater housing 270 by the second environment. Underwater housing 270 may include housing interface 280 and insert 290.

Housing interface 280 may include hardware and/or software based logic to allow for remote control of features of terminal 100. For example, housing interface 280 may operate with buttons that allow a user to take an underwater picture with terminal 100 while terminal 100 in supported inside underwater housing 270. A button may be coupled to terminal 100 via system connector 155 and/or system interface 260 via a cable and/or wireless link, such as a free space optical link, acoustic link, or radio frequency link.

Insert 290 may include a structure or device to allow one or more sizes, shapes, styles and/or types of terminals 100 to be used in underwater housing 270. For example, insert 290 may be adapted to receive and support terminal 100 via a supporting volume. An implementation of underwater housing 270 may include a fixed insert adapted to receive a number of mobile terminals 100 sharing similar characteristics, such as system connector 155, a size, a shape, a volume, etc. Another implementation of underwater housing 270 may include an insert 290 that is adapted to releasably mate with an inner portion of underwater housing 270 via a mounting surface. A removable implementation of insert 290 may be configured to have varying supporting volumes and a single style of a mounting surface. Other implementations of insert 290 may be configured differently.

As will be described in detail below, terminal 100, consistent with principles of the invention, may perform certain operations relating to capturing an underwater image. Terminal 100 may perform these operations in response to processing logic 210 executing software instructions of an image capturing application contained in a computer-readable medium, such as storage 220. A computer-readable medium may be defined as a physical or logical memory device and/or carrier wave.

The software instructions may be read into storage 220 from another computer-readable medium or from another device via communication interface 240. The software instructions contained in storage 220 may cause processing logic 210 to perform processes that will be described later. Alternatively, hardwired circuitry may be used in place of or in combination with software instructions to implement processes consistent with principles of the invention. Thus, implementations consistent with principles of the invention are not limited to any specific combination of hardware circuitry and software.

### Exemplary Underwater Housing

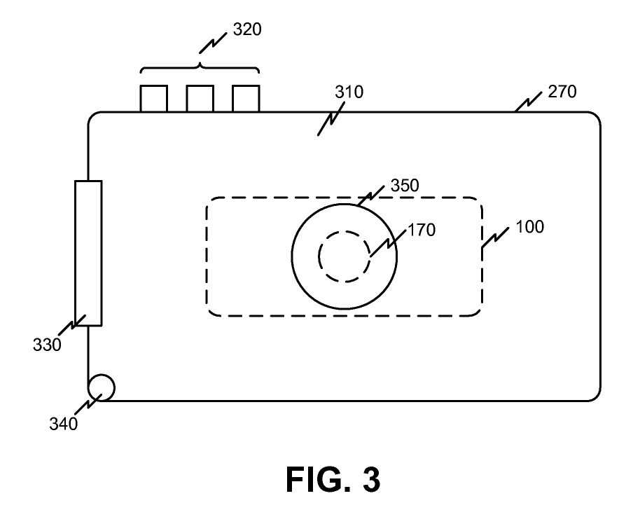

FIG. 3 illustrates exemplary underwater housing 270. Underwater housing 270 may include substantially any structure or device that can support terminal 100 in a manner that allows terminal 100 to take pictures while inside underwater housing 270. Implementations of underwater housing 270 may be molded, machined, and/or fabricated via other techniques. Implementations of underwater housing 270 may be fabricated as single piece and/or multi-piece implementations. For example, an implementation may include a front portion and a rear portion.

Underwater housing 270, as illustrated in FIG. 3, may include front portion 310, buttons 320, latch 330, loop 340, and window 350. Front portion 310 may be made of transparent material and/or may be made of semi-transparent or opaque material with a clear window 350. Front portion 310 may be adapted to mate with a rear portion of underwater housing 270 (not shown in FIG. 3) to form a watertight enclosure (underwater housing 270) for terminal 100.

Buttons 320 may include devices adapted to cause terminal 100 to perform a function. In an implementation, buttons 320 may cause terminal 100 to turn on/off camera 250, focus camera 250, take a picture, store a picture, dial a phone number, etc., while terminal 100 is located inside underwater housing 270. Buttons 320 may be sealed to prevent moisture from reaching internal components of buttons 320. Buttons 320 may be implemented via spring driven, membrane-based, toggle-based, slideable, and/or other types of buttons/keys. Buttons 320 can be supported on front portion 310, a rear portion of underwater housing 270 (not shown in FIG. 3), and/or elsewhere on underwater housing 270. Implementations of buttons 320 may further be located remotely with respect to underwater housing 270 and may coupled to underwater housing 270 via a cable and/or free space link.

Latch 330 may include a device to maintain a portion of front portion 310 in a determined relationship with a rear portion of underwater housing 270. Latch 330 may be an electromechanical, mechanical, and/or magnetic device. Latch 330 may be implemented via a cammed, spring driven, keyed, lock-based, threaded, slideable, etc., retaining device.

Loop 340 may include a device or structure to receive a lanyard, strap, clip, buckle, and/or other type of device that can be used to prevent underwater housing 270 from becoming disassociated from a user. In one implementation, loop 340 may include a hole passing through front portion 310 and/or a rear portion of underwater housing 270.

Window 350 may include a device or structure to pass light and/or other optical information from the exterior surface of underwater housing 270 to an interior volume of underwater housing 270. Implementations of window 350 may be made of optical quality glass, plastic, ceramic, etc. Implementations of window 350 may be configured to magnify and/or reduce images if desired. In one implementation, window 350 may be adapted to pass subject information to lens 170 of terminal 100 when terminal 100 is supported inside underwater housing 270.

### Exemplary Rear Housing Portion

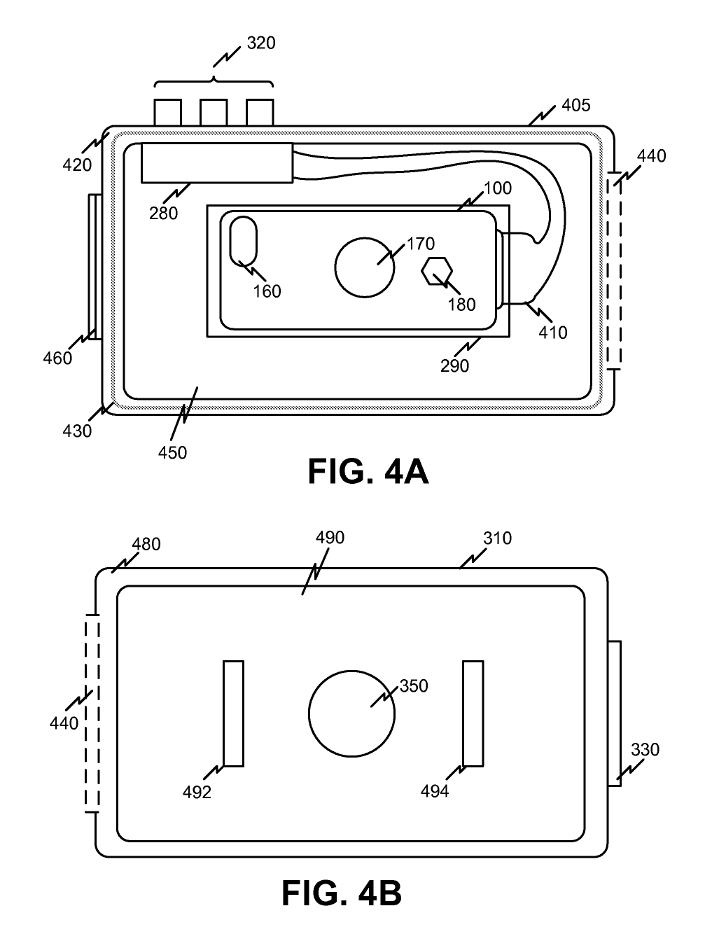

FIG. 4A illustrates the interior of a rear portion 405 of exemplary underwater housing 270 of FIG. 3. Rear portion 405 may be configured to mate with front portion 310 to form a substantially watertight seal. Rear portion 405 may be fabricated from the same material used for front portion 310 and/or from a different material. Rear portion 405 may include terminal 100, housing interface 280, insert 290, buttons 320, cable 410, rear mating surface 420, o-ring 430, hinge 440, rear volume 450, and receiving member 460. Insert 290 may be configured to house terminal 100.

Terminal 100, housing interface 280, insert 290, and buttons 320 may be configured and implemented as described in connections with FIGS. 1A and B, FIG. 2, and FIG. 3, respectively. Cable 410 may include a device to connect terminal 100 to housing interface 280. Cable 410 may include wires and/or optical fibers and may be implemented via one or more strands. Multi-strand implementations of cable may be implemented in round, flat, and/or other geometries. Cable 410 may be terminated on a proximal end with a terminal connector that is adapted to mate with system connector 155. Cable 410 may be terminated on a distal end with an interface connector adapted to mate with housing interface 280. Modular implementations of underwater housing 270 may include cable 410 that includes a single type of connector on the distal end to mate with housing interface 280 and that has varying types of connectors on the proximal end to mate with various types and/or models of terminal 100. Another implementation of cable 410 may include a connector on the proximal end that is configured to mate with a number of terminals 100, such as terminals 100 made by a single manufacturer.

Mating surface 420 may include a surface of rear portion 405 that is adapted to contact a mating surface on front portion 310 to form a substantially water tight seal. Mating surface 420 may include a channel to receive a sealing device, such as a gasket, o-ring, etc.

O-ring 430 may include a device that operates with mating surface 420 and/or a mating surface of front portion 310 to form a substantially watertight seal when front portion 310 is mated against rear portion 405 in cooperation with latch 330. O-ring 430 may be made of a compliant material, such as rubber, polymer, or other material, adapted to expand when rear portion 405 and front portion 310 are in a mated position with respect to each other.

Hinge 440 may include a device to allow rear portion 405 to move in relation to front portion 310. In an implementation, hinge 440 may allow rear portion 405 to pivot with respect to front portion 310. Hinge 440 may be adapted to allow a watertight seal between front portion 310 and rear portion 405 when front portion 310 and rear portion 405 are mated together. Alternative implementations of housing 270 may replace hinge 440 with a latch and/or a keyed retaining device.

Rear volume 450 may include an interior portion formed by surfaces of rear portion 405. Rear volume 450 may be sized to accommodate devices, such as terminal 100, insert 290, cable 410, etc.

Receiving member 460 may include a device or structure that operates with latch 330 to facilitate forming a watertight seal when front portion 310 and rear portion 405 are mated together. Receiving member 460 may be adapted to be engaged by a surface of latch 330.

Implementations of rear portion 405 may include a display window (not shown in FIG. 4A) to allow a user to view image information displayed via display 140 through underwater housing 270 when terminal 100 is operated within underwater housing 270. For example, a user may face an outer surface of rear portion 405 (e.g., a surface of rear portion 405 exposed to water). The user may view a representation of an image that is being focused on via lens 170. The user may capture the image representation via button 320 and/or another device when desired.

### Exemplary Front Housing Portion

FIG. 4B illustrates the interior of front portion 310 of exemplary underwater housing 270. Front portion 310 may include latch 330, window 350, hinge 440, mating surface 480, front volume 490, and supporting members 492 and 494. Latch 330, window 350 and hinge 440 may be configured and implemented as described in FIGS. 3 and 4A, respectively. Mating surface 480 may include a surface adapted to mate with mating surface 420 and/or o-ring 430 to form a watertight seal along mating portions of front portion 310 and rear portion 405. Front volume 490 may include a volume formed by a surface of front portion 310. Front volume 490 may be configured to contain supporting members 492 and 494, a portion of insert 290, cable 410 and/or terminal 100. Supporting members 492 and 494 may include devices or structures adapted to support a surface of terminal 100. For example, supporting members 492 and 494 may be adapted to maintain a determined pressure on housing 101 to maintain terminal 100 in a determined relationship with respect to insert 290, rear portion 405 and/or window 350.

### Exemplary Inserts

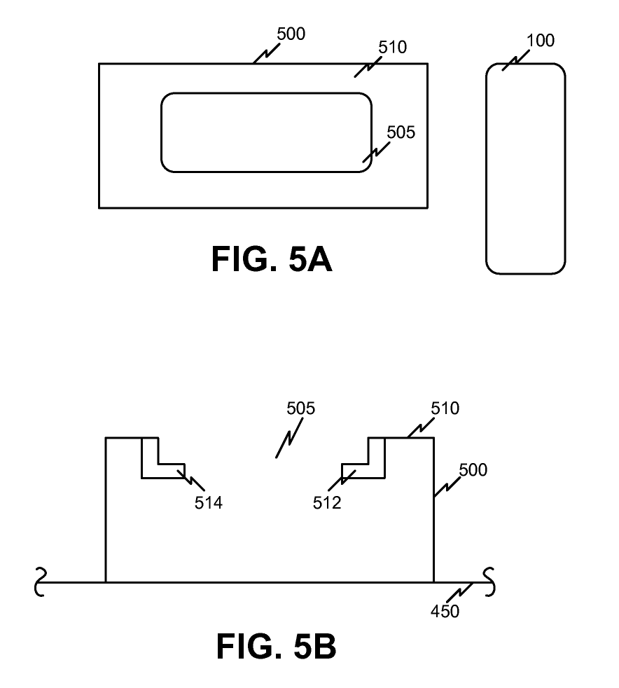

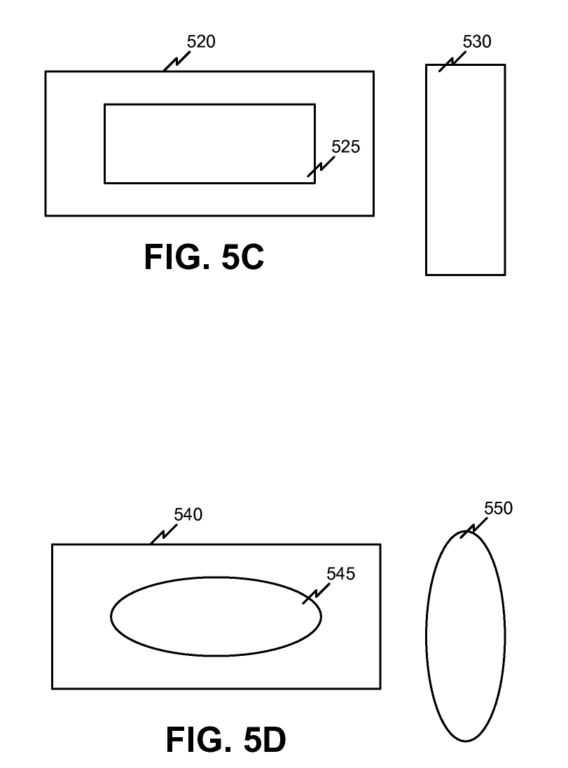

FIGS. 5A-5D illustrate exemplary inserts adapted for use with underwater housing 270 of FIG. 3. FIG. 5A illustrates an implementation of an insert 290, here insert 500, having a receiving volume 505 that is adapted to receive a terminal having a first shape, here terminal 100. Receiving volume 505 may be adapted to support terminal 100 in a determined position with respect to a top surface 510 of insert 500.

FIG. 5B illustrates a cutaway view of insert 500 showing exemplary structures for supporting terminal 100 in a determined relationship with respect to top surface 510 of insert 500. Insert 500 (FIG. 5B) may include a first supporting member 512 and a second supporting member 514. First and second supporting members 512, 514 may be fabricated from a material that can support terminal 100 and/or other types of terminals (not shown in FIG. 5B). For example, supporting members 512 and 514 may be flexible or moveable to support terminals 100 of various sizes. First and second supporting members 512, 514 may be sized and positioned to allow a user of underwater housing 270 to view display 140 through insert 290 or 500 and/or a surface of rear portion 405. A lower portion of insert 500 may be supported on an inner surface of rear portion 405, such as a portion of an inner surface forming a portion of rear volume 450. An implementation of insert 505 may be configured with receiving volume 505 having a length ranging from approximately 8 centimeters (cm) to 18 cm and a width ranging from approximately 4 cm to 10 cm.

FIG. 5C illustrates a second implementation of insert 290, here insert 520, that includes receiving volume 525. Receiving volume 525 may be adapted to support terminal 530 in a determined position, where terminal 530 may have a second shape with respect to terminal 100.

FIG. 5D illustrates a third implementation of insert 290, here insert 540, that includes receiving volume 545. Receiving volume 545 may be adapted to support terminal 550 in a determined position, where terminal 550 has a third shape with respect to terminal 100.

Implementations of inserts 500, 520, and/or 540 may be adapted to support a number of terminals 100 having similar characteristics, such as interface connectors, sizes, shapes, etc. Inserts 500, 520 and/or 540 may further be configured to be removable or fixed. A fixed and/or removable implementation of insert 500, 520 and/or 540 may be adapted to support a number of terminals having a certain style and/or configuration of system connector 155. For example, insert 500, 520, and/or 540 may accept a first mobile terminal, a mobile second terminal, a third mobile terminal, etc., that share a certain style of system connector 155. In this example, cable 410 may be fixed to housing interface 280, e.g., via a spliced connection, at a first end and may be terminated with a connector at a second end, where the connector is adapted to mate with system connector 155 on the first mobile terminal, second mobile terminal, third mobile terminal, etc.

### Exemplary Method of Use

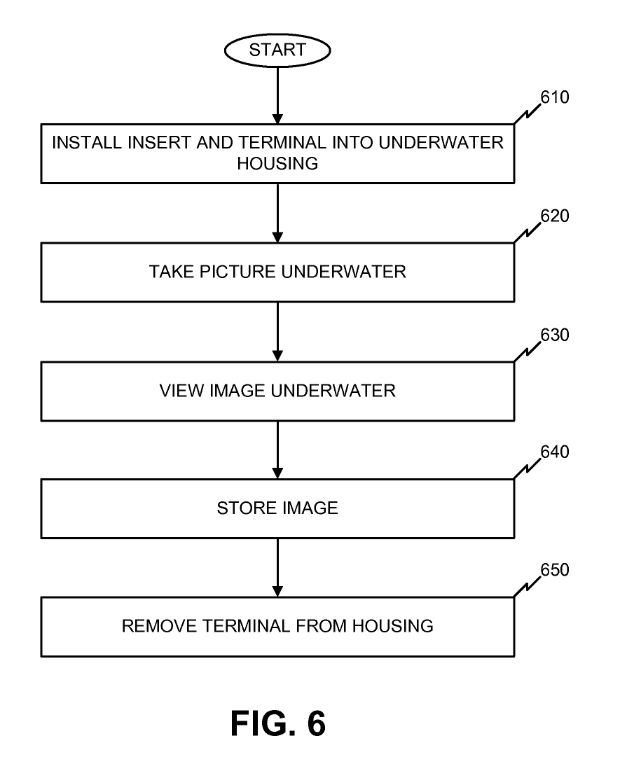

FIG. 6 illustrates an exemplary method consistent with the principles of the invention. A user may have a communication device, such as terminal 100. The user may wish to use terminal 100 to take photographs underwater. The user may select an insert, such as insert 290, 500, 520, or 540 based on a configuration of his/her terminal 100, 530 or 550. The user may further select underwater housing 270, which may be a universal underwater housing 270. The universal underwater housing may use one or more inserts to adapt the universal underwater housing to fit substantially any number of terminals. The universal underwater housing may further be adapted to handle non-waterproof cameras and/or other devices having built-in cameras. The universal underwater housing may use other types of inserts with these other devices.

The user may install insert 290 and terminal 100 into underwater housing 270 (block 610). For example, the user may install insert 290 into rear portion 405. In one implementation, insert 290 may be retained in rear portion via hook and loop fastening devices, adhesive-based fastening devices, threaded fasteners, keyed fasteners, etc. The user may install terminal 100 into insert 290. The user may connect a proximal end of cable 410 to system connector 155 and may connect a distal end of cable 410 to housing interface 280.

The user may place front portion 310 over rear portion 405 and may engage latch 330 with receiving member 460 to compress o-ring 430. Terminal 100 may be supported in a waterproof volume formed by front volume 490 and rear volume 450 when front portion 310 and rear portion 405 are in a mated relationship with respect to each other.

The user may take a digital picture underwater (block 620). For example, the user may point lens 170 in camera 250 towards an underwater subject. Optical information may be reflected from the subject through window 350 and into lens 170. The user may view an image of the subject via display 140 from a backside of underwater housing 270. The user may manipulate one or more buttons 320 to capture an image with camera 250. For example, depressing a button 320 may send an electrical signal through housing interface 280 and cable 410 to system connector 155. System connector 155 may pass the signal to system interface 260. System interface 260 may interact with processing logic 210 and camera 250 to record an image.

The user may view the captured image via display 140 while underwater (block 630). For example, camera 250 may be configured to send the image to display 140 when camera 250 receives an instruction to capture an image.

The user may store the image (block 640). For example, the user may provide a storage instruction to terminal 100 via button 320 and/or another device. Display 140 may send the image to storage 220 when display 140 receives an instruction to store an image. Storage 220 may store the image to a fixed media and/or a removable media.

The user may exit the underwater environment when he/she is finished taking underwater pictures. The user may open underwater housing 270 by releasing latch 330. The user may separate front portion 310 from rear portion 405. For example, front portion 310 may pivot with respect to rear portion 405 via hinge 440. The user may remove terminal 100 from underwater housing 270 by removing terminal 100 from insert 290 (block 650). The user may connect terminal 100 to an external device, such as a computer, and may transfer digital images to the external device. Alternatively, the user may remove a memory card from terminal 100, where the memory card includes the digital images, and may insert the memory card into an external device.

The user may reconfigure underwater housing 270 by replacing insert 290 with another type of insert, e.g., inserts 500, 520 and/or 540, to use underwater housing 270 with another type of terminal, e.g., terminal 530 and/or 550.

Underwater housing 270 may be configured in substantially any number of ways. For example, implementations of underwater housing 270 may include a leak detector, a compass, a depth sensor, a GPS sensor and/or readout, an LCD display to display subject information to a user, a clock, a countdown timer, etc. These implementations of underwater housing 270 may be adapted to operate with substantially any type of terminal, such as terminal 100, 525, and/or 545, using one or more inserts, such as inserts 290, 500, 520 and/or 540.

### CONCLUSION

Implementations consistent with principles of the invention may allow non-waterproof mobile terminals to be used underwater to take pictures.

The foregoing description of preferred embodiments of the invention provides illustration and description, but is not intended to be exhaustive or to limit the invention to the precise form disclosed. Modifications and variations are possible in light of the above teachings or may be acquired from practice of the invention.

While a series of acts has been described with regard to FIG. 6, the order of the acts may be modified in other implementations consistent with the principles of the invention. Further, non-dependent acts may be performed in parallel.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as hardwired logic, an application specific integrated circuit, a field programmable gate array, a microprocessor, software, or a combination of hardware and software.

It should be emphasized that the term “comprises/comprising” when used in this specification and/or claims is taken to specify the presence of stated features, integers, steps or components but does not preclude the presence or addition of one or more other features, integers, steps, components or groups thereof.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A housing, comprising:
a first portion, comprising:
a window configured to allow a lens to capture images viewed through the window, and
a first mating surface; and
a second portion, comprising:
a second mating surface adapted to mate with the first mating surface to form a watertight seal,
at least one button to provide a signal to a terminal supported in the second portion, and
a receiving surface on an inner surface of the second portion adapted to receive an insert, where the insert is adapted to be removeably coupled to the receiving surface on a first side and to receive the terminal via a second side.

2. The housing of claim 1, wherein the second portion comprises an image window to provide image information related to a user when the user faces an outer surface of the second portion.

3. The housing of claim 2, wherein the signal is produced in response to a user action.

4. The housing of claim 1, wherein the first portion and the second portion are used with the terminal to take a picture underwater when the first portion and the second portion are mated together.

5. The housing of claim 1, further comprising:
a cable to connect the at least one button to the terminal, where the cable is adapted to carry the signal.

6. The housing of claim 1, further comprising:
a latch to maintain the first portion and the second portion in a mated relationship.

7. The housing of claim 1, wherein the at least one button comprises a first button configured to turn on a camera included in the terminal and a second button configured to take a picture using the camera.

8. The housing of claim 1, wherein the watertight housing is adapted to accept any of a plurality of inserts, where the plurality of inserts are adapted to receive a plurality of terminals having different sizes or shapes associated therewith.

9. An insert, comprising:
an upper surface adapted to receive a terminal;
a supporting member adapted to maintain the terminal in a determined relationship with respect to the upper surface; and
a lower surface adapted to releasably couple with an inner surface of a watertight housing, where the watertight housing is adapted to allow the terminal to take a picture while the watertight housing is submerged.

10. The insert of claim 9, wherein the upper and lower surface form a receiving volume having a length varying from approximately 8 centimeters (cm) to 18 cm and a width varying from approximately 4 cm to 10 cm.

11. A housing, comprising:
a window to allow subject information to reach a lens of a terminal supported in the housing;
an insert supported via an inner surface of the housing, where the insert is adapted to receive the terminal and to maintain the terminal in a determined position with respect to the window;
at least one input device located on an outer surface of the housing;
a cable releasably coupled to the at least one input device via a first end and to the terminal via a second end, where the cable is adapted to pass a signal from the at least one input device to the terminal when the at least one input device is activated.

12. The housing of claim 11, wherein the insert is adapted to be releasably supported via the inner surface of the housing.

13. The housing of claim 11, wherein the cable is one of a plurality of cables that are adapted to connect the at least one input device to a plurality of different terminals.

14. The housing of claim 11, wherein the inner surface of the housing is further configured to support a plurality of inserts associated with a plurality of different terminals.

15. The underwater housing of claim 11, wherein the cable or the at least one input device allow the terminal to be remotely controlled.

16. A method, comprising:
receiving an insert adapted to support a terminal in a determined relationship with respect to an inner surface of an underwater housing;
receiving the terminal via the insert;
receiving a user input via a button while the underwater housing is substantially submerged;
sending a signal related to the user input to the terminal via a cable, where the signal causes the terminal to capture an image via a lens proximate to a window in the underwater housing; and
providing a representation of the captured image to the user through the underwater housing.

17. The method of claim 16, further comprising:
storing the captured image in a memory in response to a second user input received via a second button.

18. The method of claim 16, further comprising:
determining if water is present inside the underwater housing.

19. A device, comprising:
an enclosure configured to receive a mobile terminal, the enclosure forming a watertight seal; and
at least one input device located on an outer surface of the enclosure, the at least one input device being configured to transmit electrical signals to a camera function of the mobile terminal when activated by a user.

20. The device of claim 19, further comprising:
an insert adapted to receive the mobile terminal, where the insert maintains the terminal in a determined relationship with respect to a window of the enclosure.
